(19) United States
(12) Patent Application Publication
(10) Pub. No.: US 2016/0156062 A1
(43) Pub. Date: Jun. 2, 2016

(54) Solid-State Batteries with Electrodes Infused with Ionically Conductive Material and Methods for Forming the Same

(71) Applicant: Intermolecular, Inc., San Jose, CA (US)

(72) Inventors: Karl Littau, Palo Alto, CA (US); Abraham Anapolsky, San Mateo, CA (US)

(21) Appl. No.: 14/558,235

(22) Filed: Dec. 2, 2014

(51) Int. Cl. H01M 10/052; H01M 4/134; H01M 10/0562; H01M 10/058; H01M 10/0566

(52) U.S. Cl. CPC H01M 10/052; H01M 10/058; H01M 10/0566; H01M 10/0562; H01M 4/134; H01M 2220/30; H01M 2300/0068; H01M 2300/0025

(57) ABSTRACT

Embodiments provided herein describe solid-state lithium batteries and methods for forming such batteries. A first current collector is provided. A first electrode is formed above the first current collector. The first electrode has at least one void formed therein. A fluidic, ionically-conductive material is infused into the at least one void within the first electrode. A solid electrolyte is formed above the first electrode. A second electrode is formed above the solid electrolyte. A second current collector is formed above the second electrode.

The present invention relates to solid-state batteries. More particularly, this invention relates to solid-state lithium batteries with electrodes that are infused with an ionically-conductive material and methods for forming such batteries.

### BACKGROUND

As electronic devices continue to get smaller, while the performance thereof continues to improve, there is an ever growing need for smaller, lighter, and more powerful batteries that demonstrate suitable reliability and longevity. One possible solution for these batteries is solid-state lithium batteries.

Currently, high utilization of thin, solid-film lithium-cobalt oxide electrodes is limited when the electrode thickness exceeds about 4 micrometers (μm) due to, for example, low ionic conductivity and/or high Ohmic resistivity within the electrode. Films thicker than 4 micrometers show decreased utilization of the full capacity of the electrode at charge rates above C/5. Thus, the batteries suffer from a loss of overall energy.

One cause of this decreased utilization in relatively thick films is that the bulk ionic conductivity of the electrode is relatively small when compared to good ionic conductors such as liquid, gel, or polymer electrolytes. Thick films of low ionic conductance will exhibit substantial impedance which will limit the utilization of the electrode especially at high discharge rates (e.g., >C/5). In addition thick electrode layers may contain porosity, voids, or cracks. These can occur naturally during electrode fabrication by anisotropic densification (e.g., during annealing), stress cracking, free volume creation at grain boundaries, and other means. Porosity can further reduce ionic conductance by reducing the amount of conducting pathways through the electrode. These pores and voids may particularly be an issue when relatively fast and inexpensive methods are used to form the electrodes, such as screen printing, tape casting, and electrophoretic deposition.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional view of a substrate with a current collector formed above.

FIG. 2 is a cross-sectional view of the substrate of FIG. 1 with an electrode formed above the current collector.

FIG. 3 is a cross-sectional view of the substrate of FIG. 2 with a fluidic ionically-conductive material infused into voids within the electrode.

FIG. 4 is a cross-sectional view of the substrate of FIG. 3 showing the electrode in greater detail.

FIG. 5 is a cross-sectional view of the substrate of FIG. 2 with a protective material deposited above the electrode.

FIG. 6 is a cross-sectional side view of a solid-state battery according to some embodiments.

FIG. 7 is a flow chart illustrating a method for forming a solid-state battery according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims, and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

The term “horizontal” as used herein will be understood to be defined as a plane parallel to the plane or surface of the substrate, regardless of the orientation of the substrate. The term “vertical” will refer to a direction perpendicular to the horizontal as previously defined. Terms such as “above”, “below”, “bottom”, “top”, “side” (e.g. sidewall), “higher”, “lower”, “upper”, “over”, and “under”, are defined with respect to the horizontal plane. The term “on” means there is direct contact between the elements. The term “above” will allow for intervening elements.

In some embodiments, methods are provided for forming solid-state battery electrodes (and/or solid-state batteries) in such a way as to reduce the loss of ionic conductivity often associated with relatively thick electrodes (e.g., greater than 4 micrometer (μm)). In some embodiments, the ionic conductivity of the electrodes is improved by infusing a fluidic, ionically-conductive material into the electrodes, particularly the pores, voids, and other free volume formed in the electrodes. The fluidic, ionically-conductive material may include (or be made of) an ionic liquid, a flowable solid electrolyte material, or a combination thereof.

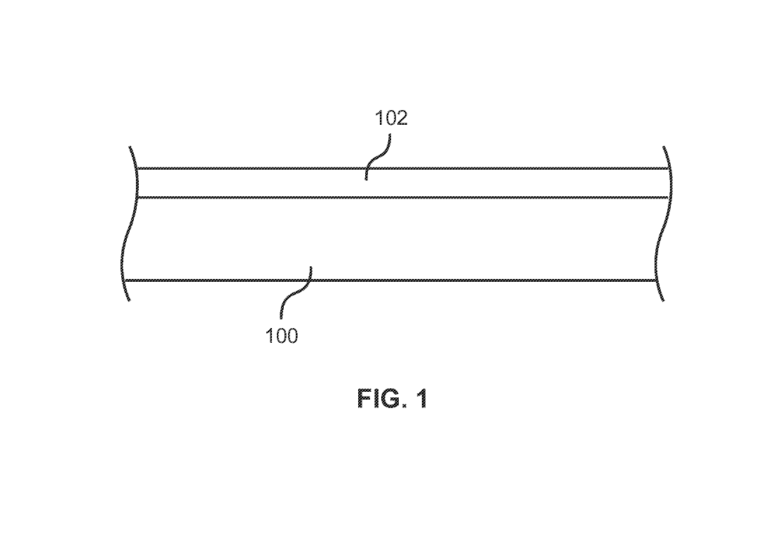

FIGS. 1-5 are cross-sectional views of a substrate, illustrating a method for forming an electrode for a solid-state battery, according to some embodiments. Referring to FIG. 1, a substrate 100 is provided. In some embodiments, the substrate 100 includes (or is made of) aluminum oxide (e.g., alumina), silicon oxide (e.g., silica), zirconium oxide (e.g., zirconia), aluminum nitride, a semiconductor material, such as silicon and/or germanium, a metal foil (e.g., aluminum, titanium, stainless steel, etc.), and/or a polymer or plastic. The substrate 100 may have a thickness of, for example, between about 5 micrometers (μm) and about 5 millimeters (mm).

Still referring to FIG. 1, a current collector (e.g., a cathode current collector) 102 is formed above the substrate 100. In some embodiments, the current collector 102 includes (or is made of) a noble metal, such as gold, platinum, cobalt, palladium, or a combination thereof. The current collector 102 may have a thickness of, for example, between about 0.1 μm and about 3.0 μm. The current collector may be formed using any suitable process, such as physical vapor deposition (PVD) (e.g., sputtering) or plating. In some embodiments, the current collector 102 includes a layer of cobalt (e.g., 0.1 μm thick) and a thinner layer of gold formed over the cobalt. Although the current collector 102 is shown as being formed above the substrate 100, it should be understood that in some embodiments, the current collector 102 may be integral with the substrate 100, while in other embodiments, the substrate 100 may not be included at all.

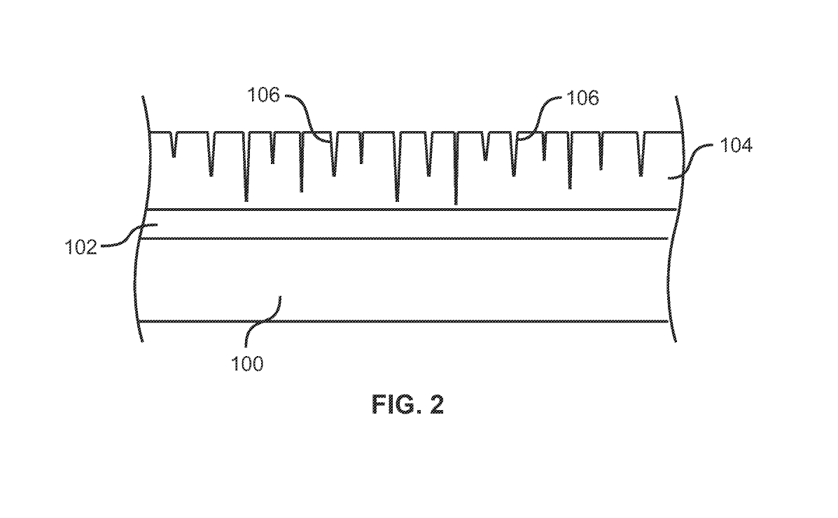

As shown in FIG. 2, an electrode (e.g., a cathode) 104 is formed above the current collector 102. In some embodiments, the electrode 104 is made of a layer that includes lithium and cobalt (e.g., lithium-cobalt oxide) and has a thickness of, for example, greater than about 4 μm (e.g., even greater than 10 μm), such as between about 5 μm and about 15 μm. The electrode 104 may be formed using, for example, PVD (e.g., sputtering), a sol-gel process, screen printing, tape casting, electrophoretic deposition, or any other suitable method.

Still referring to FIG. 2, the electrode 104 includes a series of voids (e.g., cracks and/or pores) 106, which may manifest during the deposition/formation process. As depicted in FIG. 2, the voids 106 have manifested as cracks in the electrode 104. The cracks 106 may vary in width and depth. For example, in some embodiments, the width of the cracks 106 varies between about 1 nanometer (nm) and about 250 nm, while the height (or depth) of the cracks 106 varies between a few nanometers and perhaps as much as the entire thickness of the electrode 104 (e.g., 15 μm). Although not shown, other voids, such as pores or gaps, may be present isolated or in connection with the cracks 106 and have dimensions from 10 nm to 1 μm, or even as large as nearly the entire film thickness. The voids 106 may be more prominent (i.e., larger and greater in number) when the electrode is formed using screen printing, tape casting, and electrophoretic deposition, as opposed to sputtering.

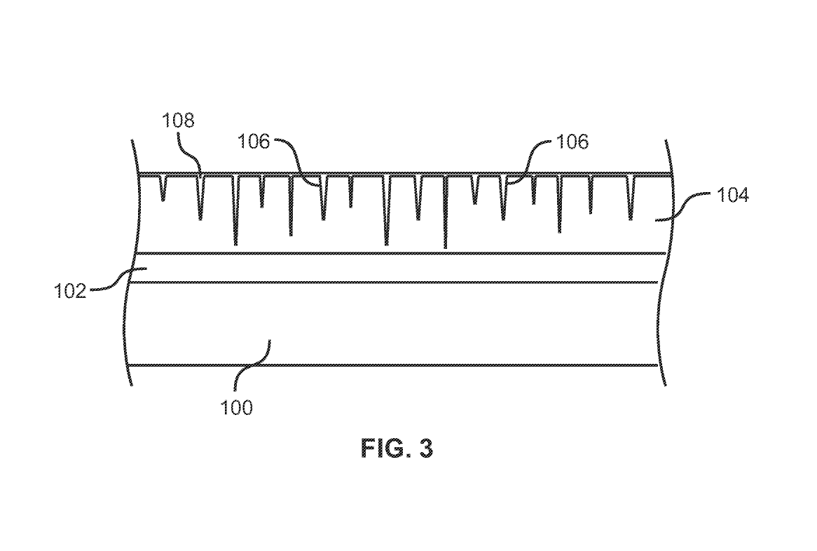

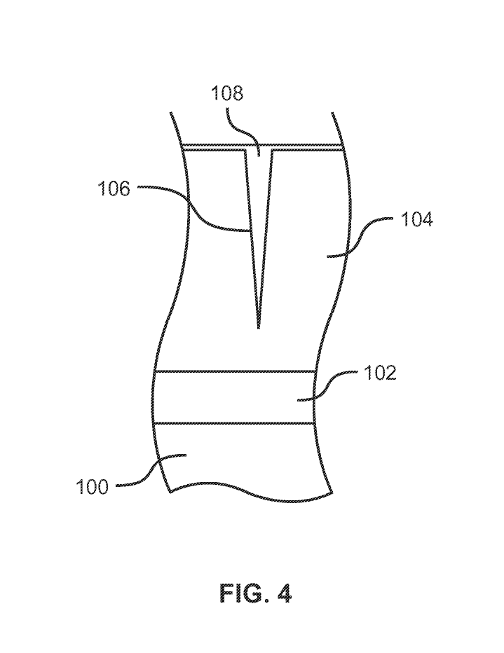

Referring now to FIG. 3, a fluidic, ionically-conductive material 108 is then infused into the electrode 104, particularly the voids 106 within the electrode 104. In some embodiments, the fluidic, ionically-conductive material 108 at least partially fills at least some of the voids 106, while in some embodiments, all of the voids 106 are completely filled. This is shown more clearly in FIG. 4, which is a “zoomed in” view of one of the voids 106 after the fluidic, ionically-conductive material has been infused into the electrode 104.

In some embodiments, the fluidic, ionically-conductive material 108 includes a liquid, such as a lithium-conducting, room-temperature ionic liquid. Any ionic liquids that are both compatible with the material of the electrode (e.g., lithium-cobalt oxide) and have sufficient lithium ionic conductivity may be used. Additionally, it may be preferable that the ionic liquid(s) have low freezing points, low viscosities, and large electrochemical stability windows (e.g., do not react with lithium-cobalt oxide, etc.).

Examples of suitable ionic liquids include, but are not limited to, 1-ethyl-3-methylimidazolium bis(trifluoromethylsulfonyl)imide, 1-ethoxymethyl-3-methylimidazolium bis(trifluoromethylsulfonyl)imide, n-butyl-n-methyl pyrrolidinium bis(trifluoromethylsulfonylimide), n-propyl-n-methyl pyrrolidinium bis(trifluoromethylsulfonylimide), and the corresponding BF₄ and PF₆ salts. In some embodiments, the ionic liquid also includes a quantity of a lithium salt, such as lithium bis(trifluoromethane sulfonylimide, sufficient to obtain a 0.001 M to 1.0 M concentration (e.g., such a type and quantity of salt may be added to the ionic liquid before it is infused into the electrode 104).

The ionic liquid may be deposited onto (and/or infused within) the electrode 104 (e.g., through a side of the electrode 104 opposite the substrate 100) using any suitable method, such as bath immersion, spray coating, spin coating, puddle coating, brush coating, and rolling. Agitation, heat, sonication, or other energetic, or physical method, may be used to enhance the penetration of the ionic liquid into the electrode 104.

In some embodiments, the fluidic, ionically-conductive material 108 includes a solid material, such as a flowable solid electrolyte material. The flowable solid electrolyte material may have an ionic conductivity sufficient to allow thick electrodes (e.g., greater than 4 μm) to conduct ions though the entire thickness thereof, while also being “flowable” (i.e., able to be flowed into the voids 106 of the electrode 104). For example, solid electrolytes with low glass transition temperatures may be used such that the electrode 104 (and/or the substrate 100) may be heated and the electrolyte infused into the electrode, perhaps by also applying pressure to the solid electrolyte (e.g., “pressing” the electrolyte into the electrode).

In some embodiments, the flowable solid electrolyte is a lithium phosphorous sulfide or a related compound. One particular example is Li₂S—P₂S₅. In some embodiments, the ratio of Li₂S to P₂S₅ is 70:30 by weight. In embodiments in which the flowable solid electrolyte is a lithium phosphorous sulfide, the electrolyte may be suitably flowable at room temperature (e.g., 25° C.) under applied pressure.

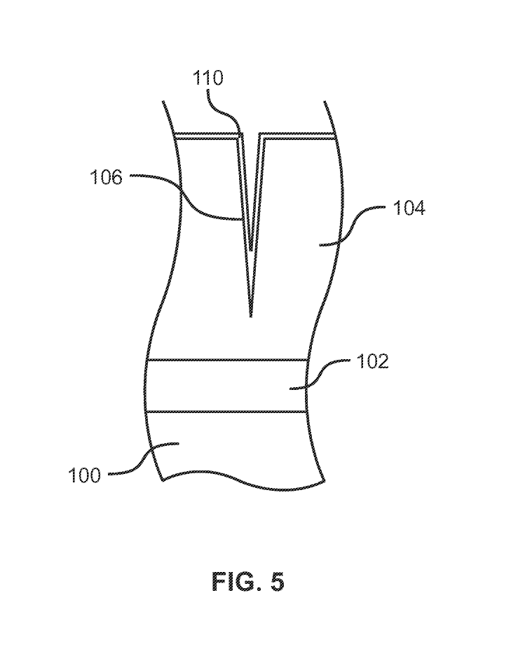

Referring now to FIG. 5, in some embodiments in which a flowable solid electrolyte is used, a protective coating (or material) 110 is formed (or deposited) on the electrode 104 before the flowable solid electrolyte is infused into the electrode 104. In some embodiments, the protective coating 110 includes (or is made of) lithium niobate, silicon oxide, aluminum oxide, hafnium oxide, titanium oxide, another ionically conducting metal or metal oxide, or a combination thereof. The protective coating 110 may be formed using, for example, atomic layer deposition (ALD) and have a thickness of, for example, between about 4 Angstroms (Å) and about 1 nm. As is shown in FIG. 4, the protective coating 110 may conform to the shape of the surface of the electrode 104. In particular, the protective coating 110 may be formed on the various sidewalls of the voids 106 such that the entire surface of the electrode 104 is covered.

The protective coating 110 may prevent the flowable solid electrolyte material from reacting with the material of the electrode 104, which may otherwise result in degradation of the performance (e.g., capacity) of the battery with repeated cycling. The protective coating 110 may be particularly beneficial when the electrode 104 includes lithium-cobalt oxide and the flowable solid electrolyte includes a lithium phosphorous sulfide.

After the electrode 104 has been infused with the flowable solid electrolyte or the ionic liquid, any excess or unwanted electrolyte material on the surface of the electrode 104 may be removed, which may effectively planarize the electrode 104. This process may be performed either mechanically (e.g., by polishing or other method), chemically (e.g. dissolution using a solvent treatment), or using a light ion etch. Additionally, the surface of the electrode 104 may be cleaned to, for example, enhance the adhesion of the solid electrolyte (described below) to the infused cathode material. Cleaning methods such as an oxygen plasma treatment, ozone treatment, an organic solvent, an argon ion treatment, or mechanical abrasion may be used.

Although not specifically shown, in some embodiments, the electrode 104 is formed such that the voids 106 manifest as pores. For example, the electrode 104 may be formed using a method in which the material contains some solids (e.g., powders mixed with a binder such as ethyl cellulose which are removed during sintering). Examples of such methods includes screen printing, stencil printing, doctor blading, tape casting, gravure printing, and other printing or casting methods. After the material of the electrode is deposited, a sintering process may be performed, for example, to increase the density of the material. This annealing may also be required in order to adjust the crystallographic orientation of the material of the electrode 104 for optimal performance.

The heating process may be performed in the same processing chamber in which the electrode 104 (and perhaps the current collector 502) is formed (i.e., “in situ”). Alternatively, the heating process may be performed in a different processing chamber than that used to form the electrode 104 (i.e., “ex situ”). In some embodiments, the electrode 104 is heated to a temperature of, for example, greater than about 600° C. (e.g., between about 600° C. and about 800° C.) during the heating process. The heating process may be performed in a gaseous environment including oxygen, nitrogen, argon, and/or hydrogen (e.g., 80% nitrogen, 20% oxygen, air/atmosphere, etc.) with either ambient humidity, or no humidity. In some embodiments, the heating process is performed for a duration of, for example, greater than 30 minutes (e.g., 30-60 minutes). The heating process may utilize a temperature ramp rate of, for example, between about 5° C. and about 10° C. per minute (e.g., starting from room temperature).

Such a process may result in electrode material containing pores due to anisotropic densification, stress cracking, and free volume creation at grain boundaries or other by other means. The fluidic, ionically-conductive material 108 (e.g., an ionic liquid or a flowable solid electrolyte) may then be infused into the pores in a manner similar those described above.

In some embodiments, the electrode material formed in such a manner (i.e., resulting in pores within the electrode 104) may form a first (or lower) portion of the electrode 104, and a second (or upper) portion of the electrode 104 is formed above. The second portion of the electrode 104 may be formed in a way that the material is deposited with a higher density that the density of the initially deposited material of the first portion of the electrode 104, such as sputtering. After the second portion of the electrode 104 is formed, the fluidic, ionically-conductive material 108 (e.g., an ionic liquid or a flowable solid electrolyte) may then be infused into the voids of the second portion of the electrode 104 in a manner similar those described above.

After the infusion of the fluidic, ionically-conductive material into the electrode 104, the substrate 100, the current collector 102, and the electrode 104 may be used to form a solid-state lithium battery in an otherwise convention manner. However, is should be understood that in some embodiments, the fluidic, ionically-conductive material 108 is infused into the electrode 104 through a side thereof that is adjacent to the substrate 100 (and/or the current collector 102), or through fluidically connected passageways either laterally across the substrate 100 but beneath the electrode 104 or vertically through the thickness of the substrate 100. This may be accomplished by using a porous substrate with an open pore structure, such as porous alumina or any standard substrate material that may be made into a porous form using known methods. In such embodiments, the infusion of the fluidic, ionically-conductive material 108 may be performed at any time after the formation of the electrode 104. For example, the infusion may performed after additional components of the solid-state battery (e.g., as described below) are formed (e.g., after anode is formed, but before the protective layer is formed).

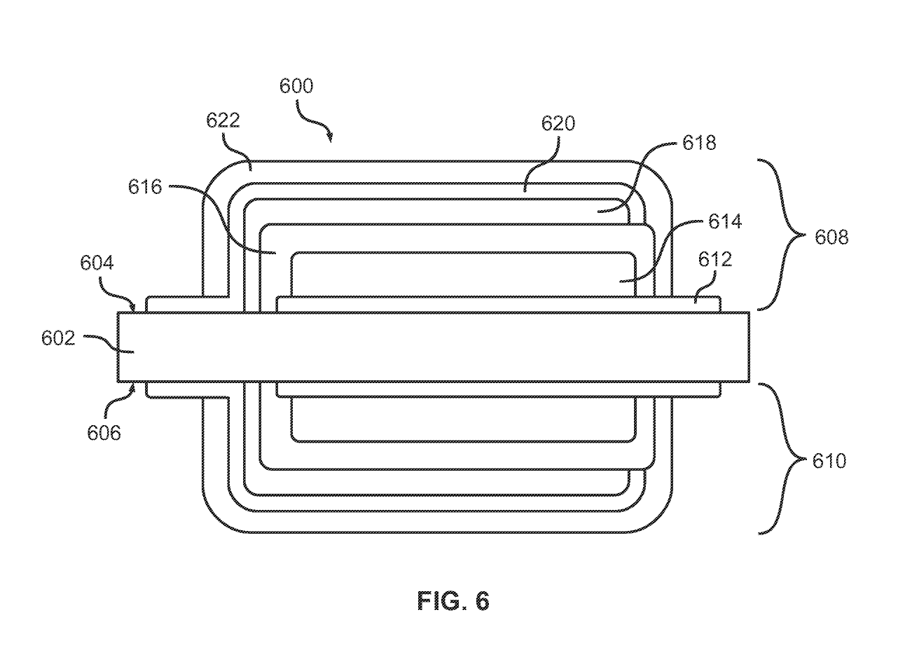

FIG. 6 illustrates a solid-state lithium battery (or battery cell) 600, according to some embodiments of the present invention. The battery 600 includes a substrate 602 having a first side 604 and a second side 606. In some embodiments, the substrate 602 is similar to the substrate 100 described above. Thus, the substrate 102 may include (or be made of) aluminum oxide (e.g., alumina), silicon oxide (e.g., silica), zirconium oxide (e.g., zirconia), aluminum nitride, a semiconductor material, such as silicon and/or germanium, a metal foil (e.g., aluminum, titanium, stainless steel, etc.), and/or a polymer or plastic. The substrate may have a thickness of, for example, between about 50 μm and about 500 μm.

The embodiment shown in FIG. 6 is a “double-sided” configuration. Thus, the battery 600 includes a first battery stack 608 formed on the first side 604 of the substrate 602 and a second battery stack 610 formed on the second side 606 of the substrate 602. In some double-sided embodiments, the first and second battery stacks 608 and 610 are identical, or substantially identical. Thus, for the purposes of this description, although only the first battery stack 608 is described in detail, it should be understood that the second battery stack 610 may be identical. In other embodiments, a “single-sided” configuration is used in which a battery stack is only formed on one side of the substrate 602.

Still referring to FIG. 6, the first battery stack 608 includes a cathode (or first) current collector 612, a cathode (or first electrode) 614, an electrolyte 616, an anode (or second electrode) 618, an anode (or second) current collector 620, and a protective layer 622.

The various layers (or components) in the battery stack 608 may be formed sequentially (i.e., from bottom to top) above the substrate 602 using, for example, physical vapor deposition (PVD) and/or reactive sputtering processing, or any other processes (e.g., plating, sol-gel processes, etc.) that are suitable depending on the material(s), thicknesses, etc. Although the components may be described as being formed “above” the previous component (or the substrate), it should be understood that in some embodiments, each layer is formed directly on (and adjacent to) the previously provided/formed component. In some embodiments, additional components (or layers) may be included between the components shown in FIG. 6 (as well as those shown in FIGS. 1-5), and other processing steps may also be performed between the formation of various components.

Still referring to FIG. 6, the cathode current collector 612 is formed above the substrate 602 (e.g., above the first side 604 of the substrate 602), and may be similar to the current collector 102 described above. Thus, in some embodiments, the cathode current collector 612 includes (or is made of) a noble metal, such as gold, platinum, or a combination thereof, and is formed using, for example, PVD or plating. The cathode current collector 612 may have a thickness of, for example, between about 0.1 μm and about 3.0 μm. As shown in FIG. 6, the cathode current collector 912 may be selectively formed on the substrate 602 such that it does not cover some portions of the substrate 602.

The cathode (or first electrode) 614 is formed above the cathode current collector 612. Although not shown in detail in FIG. 6, the cathode 614 may be similar to the electrode 104 and may be formed in a manner similar to that described above and shown in FIGS. 1-5. In the embodiment shown in FIG. 6, the cathode 614 is selectively formed above the cathode current collector 612 such that no portion of it is in direct contact with the substrate 602.

As shown in FIG. 6, the electrolyte 616 is formed above the cathode 614. In some embodiments, the electrolyte 616 includes, or is made of, lithium-phosphorous oxynitride (i.e., LiPON). The LiPON may be a “solid” electrolyte (i.e., an electrolyte that does not have a liquid component) formed using PVD, such as a sputtering process, such that the battery 600 is an “all solid-state” lithium battery. In some embodiments, the electrolyte 616 has a thickness of, for example, between about 1.0 μm and about 2.0 μm. As shown, in the depicted embodiment, the electrolyte 616 is formed such that it covers the ends of the cathode 614.

The anode (or second electrode) 618 is formed above the electrolyte 616. In some embodiments, the anode 618 includes (or is made of) lithium metal. The anode 618 may have a thickness of, for example, between 1.0 μm and 5.0 μm. In the depicted embodiment, the anode 618 is formed such that it covers an end of the electrolyte 616 opposite an exposed end of the cathode current collector 612.

The anode (or second) current collector 620 is formed above the anode 618. In some embodiments, the anode current collector 620 includes (or is made of) a conductive material that is thermodynamically and chemically stable with the material (e.g., lithium metal) of the anode 618. Suitable materials include scandium, titanium, vanadium, chromium, manganese, iron, cobalt, nickel, copper, yttrium, zirconium, lanthanum, hafnium, molybdenum, tantalum, tungsten, titanium nitride, or a combination thereof.

The anode current collector 620 may have a thickness of, for example, between about 0.1 μm and about 3.0 μm. In the depicted embodiment, the anode current collector 620 is formed such that it covers both ends of the anode 618 and a portion thereof is formed directly on an exposed portion of the substrate 602.

The protective layer 622 is formed over the anode current collector 620. In some embodiments, the protective layer 622 includes (or is made of) a nitride, such as aluminum nitride or silicon nitride. The protective layer 622 may have a thickness of, for example, between about 1.0 μm and about 30 μm. As is shown in FIG. 6, the protective layer 622 may be formed to leave portions of the cathode current collector 612 and the anode current collector 620 exposed to form electrical connections to the battery 600.

During operation of the battery 600, when the battery 600 is allowed to discharge, lithium ions (i.e., Li⁺) migrate from the anode 618 to the cathode 614 by diffusing through the electrolyte 616. When the anode and cathode reactions are reversible, as for an intercalation compound or alloy, such as lithium-cobalt oxide, the battery 600 may be recharged by reversing the current. The difference in the electrochemical potential of the lithium determines the cell voltage. Electrical connections are made to the battery 600, for both discharging and charging, through the current collectors 612 and 620.

The performance of the battery 600 may be improved due to the method described above for forming the electrode (e.g., electrode 104 and/or cathode 614). In particular, the infusion of the fluidic, ionically-conductive material into the voids within the electrode improves the overall ionic conductivity of the electrode by adding highly ionically conducting pathways through the thickness of the electrode allowing much faster ionic transport within, through, and across the electrode . As a result, the thickness of the electrode may be increased (e.g., to over 10 μm), thus increasing the energy density and power density of the battery. Additionally, the infusion of the fluidic, ionically-conductive material may allow relatively fast and inexpensive methods to be used to form the electrode (e.g., screen printing, tape casting, electrophoretic deposition, etc.) while still maintaining desirable performance.

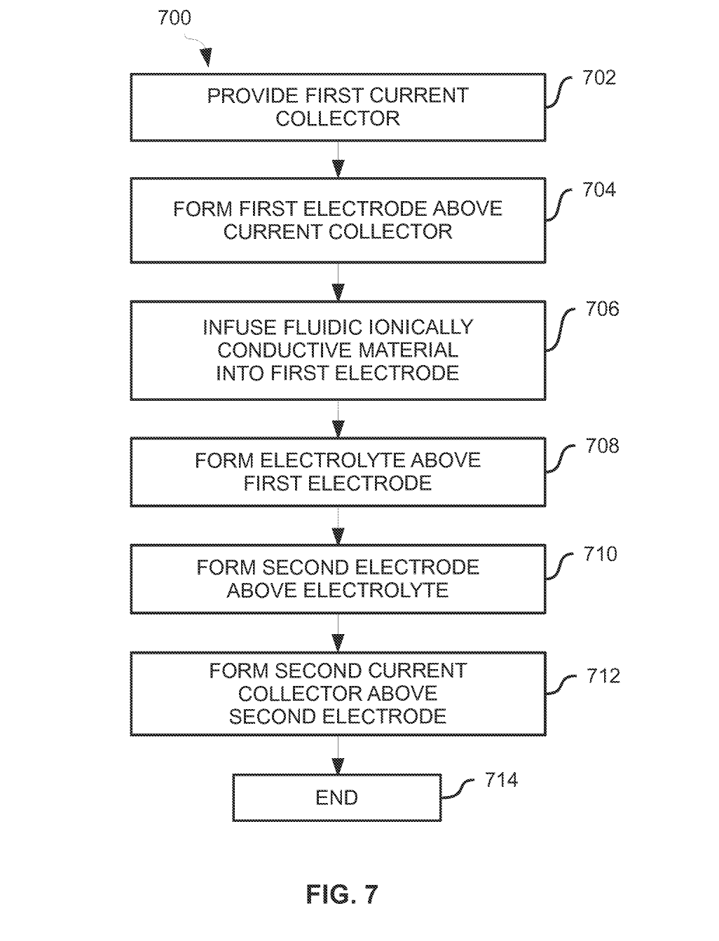

FIG. 7 illustrates a method 700 for forming a solid-state lithium battery according to some embodiments. At block 702, a first current collector (e.g., a cathode current collector) is provided. In some embodiments, the first current collector is formed above a substrate (e.g., aluminum oxide, silicon oxide, zirconium oxide, aluminum nitride, silicon, germanium, aluminum, titanium, stainless steel, and/or a polymer). The first current collector may include, for example, a noble metal, such as platinum, gold, cobalt, and/or palladium and have a thickness of, for example, between about 0.1 μm and 3.0 μm. The first current collector may be formed using, for example, physical vapor deposition (PVD) (e.g., sputtering) or plating.

At block 704, a first electrode (e.g., a cathode) is formed above the first current collector. In some embodiments, the first electrode includes lithium and cobalt (e.g., lithium-cobalt oxide) and has a thickness of, for example, between about 5 μm and about 15 μm, such as about 10 μm (or more). The first electrode may be formed using PVD (e.g., sputtering), a sol-gel process, or any other suitable method. In some embodiments, the electrode includes a series of voids (e.g., cracks and/or pores), which may manifest during the deposition/formation process.

At block 706, a fluidic, ionically-conductive material is infused into the first electrode, particular the voids therein. In some embodiments, the fluidic, ionically-conductive material at least partially fills at least some of the voids, while in some embodiments, all of the voids are completely filed. The fluidic, ionically-conductive material includes may, for example, include a liquid, such as a lithium-conducting, room-temperature ionic liquid, or a flowable solid electrolyte.

Examples of ionic liquids include, but are not limited to, 1-ethyl-3-methylimidazolium bis(trifluoromethylsulfonyl)imide, 1-ethoxymethyl-3-methylimidazolium bis(trifluoromethylsulfonyl)imide, n-butyl-n-methyl pyrrolidinium bis(trifluoromethylsulfonylimide), n-propyl-n-methyl pyrrolidinium bis(trifluoromethylsulfonylimide), and BF₄ and PF₆ salts (e.g., those corresponding to the other listed ionic liquids). In some embodiments, the ionic liquid also includes a quantity of a lithium salt, such as lithium bis(trifluoromethane sulfonylimide, sufficient to obtain a 0.001 M to 1.0 M concentration. The flowable solid electrolyte may be a lithium phosphorous sulfide, such as Li₂S—P₂S₅, or a related compound.

At block 708, an electrolyte is formed above the first electrode. The electrolyte may be a solid electrolyte formed, or deposited, using a PVD process. In some embodiments, the electrolyte includes LiPON and has a thickness of, for example, between about 1.0 μm and about 2.0 μm.

At block 710, a second electrode (e.g., an anode) is formed above the electrolyte. The second electrode may include lithium metal and have a thickness of, for example, between 1.0 μm and 5.0 μm. The second electrode may be formed using, for example, PVD (e.g., sputtering).

At block 712, a second current collector (e.g., an anode current collector) is formed above the second electrode. In some embodiments, the second current collector includes scandium, titanium, vanadium, chromium, manganese, iron, cobalt, nickel, copper, yttrium, zirconium, lanthanum, hafnium, molybdenum, tantalum, tungsten, titanium nitride, or a combination thereof. The second current collector may have a thickness of, for example, between about 0.1 μm and about 3.0 μm. The second current collector may be formed using, for example, PVD (e.g., sputtering).

Although not shown in FIG. 7, a protective layer (e.g., a nitride) may be formed above the second current collector. Additionally, in some embodiments, two sets of the components of the battery are formed on opposing sides of the substrate (i.e., a double-sided configuration), while in other embodiments, the components are only formed on one side of the substrate (i.e., a single-sided configuration). At block 714, the method 700 ends.

Thus, in some embodiments, methods for forming a solid-state battery are provided. A first current collector is provided. A first electrode is formed above the first current collector. The first electrode has at least one void formed therein. A fluidic ionically-conductive material is infused into the at least one void within the first electrode. A solid electrolyte is formed above the first electrode. A second electrode is formed above the solid electrolyte. A second current collector is formed above the second electrode.

In some embodiments, methods for forming a solid-state battery are provided. A first current collector is provided. A first electrode is formed above the first current collector. The first electrode includes lithium and cobalt and has at least one void formed therein. A fluidic ionically-conductive material is infused into the at least one void within the first electrode. The fluidic ionically-conductive material includes at least one of an ionic liquid, a flowable solid electrolyte material, or a combination thereof. A solid electrolyte is formed above the first electrode. The solid electrolyte includes lithium-phosphorous oxynitride. A second electrode is formed above the solid electrolyte. A second current collector is formed above the second electrode.

In some embodiments, solid-state batteries are provided. The solid-state batteries include a first current collector. A first electrode is formed above the first current collector. The first electrode has at least one void formed therein. A fluidic ionically-conductive material is infused into the at least one void within the first electrode. A solid electrolyte is formed above the first electrode. A second electrode is formed above the solid electrolyte. A second current collector is formed above the second electrode.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming a solid-state lithium battery, the method comprising:
providing a first current collector;
forming a first electrode above the first current collector, wherein the first electrode has at least one void formed therein;
infusing a fluidic ionically-conductive material into the at least one void within the first electrode;
forming a solid electrolyte above the first electrode;
forming a second electrode above the solid electrolyte; and
forming a second current collector above the second electrode.

2. The method of claim 1, wherein the fluidic ionically-conductive material comprises at least one of an ionic liquid, a flowable solid electrolyte material, or a combination thereof.

3. The method of claim 2, wherein the first electrode comprises lithium and cobalt.

4. The method of claim 3, wherein the fluidic ionically-conductive material comprises an ionic liquid, the ionic liquid comprising at least one of 1-ethyl-3-methylimidazolium bis(trifluoromethylsulfonyl)imide, 1-ethoxymethyl-3-methylimidazolium bis(trifluoromethylsulfonyl)imide, n-butyl-n-methyl pyrrolidinium bis(trifluoromethylsulfonylimide), b-propyl-n-methyl pyrrolidinium bis(trifluoromethylsulfonylimide), a BF₄ salt, a PF₆ salt, or a combination thereof.

5. The method of claim 4, wherein the fluidic ionically-conductive material further comprises a lithium salt.

6. The method of claim 4, wherein the infusing of the ionic liquid into the at least one void within the first electrode comprising applying the ionic liquid to the first electrode via at least one of bath immersion, spray coating, spin coating, puddle coating, brush coating, rolling, or a combination thereof.

7. The method of claim 2, wherein the fluidic ionically-conductive material comprises a flowable solid electrolyte material, wherein the flowable solid electrolyte material comprises a lithium phosphorous sulfide.

8. The method of claim 7, wherein the lithium phosphorous sulfide comprises Li₂S—P₂S₅.

9. The method of claim 7, further comprising depositing a protective material above the first electrode before the infusing of the flowable solid electrolyte material into the at least one void within the first electrode.

10. The method of claim 9, wherein the protective material comprises at least one of lithium niobate, silicon oxide, aluminum oxide, hafnium oxide, titanium oxide.

11. A method for forming a solid-state lithium battery, the method comprising:
providing a first current collector;
forming a first electrode above the first current collector, wherein the first electrode comprises lithium and cobalt and has at least one void formed therein;
infusing a fluidic ionically-conductive material into the at least one void within the first electrode, wherein the fluidic ionically-conductive material comprises at least one of an ionic liquid, a flowable solid electrolyte material, or a combination thereof;
forming a solid electrolyte above the first electrode, wherein the solid electrolyte comprises lithium-phosphorous oxynitride;
forming a second electrode above the solid electrolyte; and
forming a second current collector above the second electrode.

12. The method of claim 11, wherein the fluidic ionically-conductive material comprises an ionic liquid, the ionic liquid comprising at least one of 1-ethyl-3-methylimidazolium bis(trifluoromethylsulfonyl)imide, 1-ethoxymethyl-3-methylimidazolium bis(trifluoromethylsulfonyl)imide, n-butyl-n-methyl pyrrolidinium bis(trifluoromethylsulfonylimide), b-propyl-n-methyl pyrrolidinium bis(trifluoromethylsulfonylimide), a BF₄ salt, a PF₆ salt, or a combination thereof.

13. The method of claim 11, wherein the fluidic ionically-conductive material is infused into the at least one void within the first electrode from a side of the first electrode that is adjacent to the first current collector.

14. The method of claim 11, wherein the fluidic ionically-conductive material comprises a flowable solid electrolyte material, wherein the flowable solid electrolyte material comprises a lithium phosphorous sulfide.

15. The method of claim 14, further comprising depositing a protective material above the first electrode before the infusing of the flowable solid electrolyte material into the at least one void within the first electrode, wherein the protective material comprises at least one of lithium niobate, silicon oxide, aluminum oxide, hafnium oxide, titanium oxide.

16. A solid-state lithium battery comprising:
a first current collector;
a first electrode formed above the first current collector, wherein the first electrode has at least one void formed therein;
a fluidic ionically-conductive material infused into the at least one void within the first electrode;
a solid electrolyte formed above the first electrode;
a second electrode formed above the solid electrolyte; and
a second current collector formed above the second electrode.

17. The battery of claim 16, wherein the fluidic ionically-conductive material comprises at least one of an ionic liquid, a flowable solid electrolyte material, or a combination thereof.

18. The battery of claim 17, wherein the first electrode comprises lithium and cobalt.

19. The battery of claim 18, wherein the fluidic conductive material comprises an ionic liquid, the ionic liquid comprising at least one of 1-ethyl-3-methylimidazolium bis(trifluoromethylsulfonyl)imide, 1-ethoxymethyl-3-methylimidazolium bis(trifluoromethylsulfonyl)imide, n-butyl-n-methyl pyrrolidinium bis(trifluoromethylsulfonylimide), b-propyl-n-methyl pyrrolidinium bis(trifluoromethylsulfonylimide), a BF₄ salt, a PF₆ salt, or a combination thereof.

20. The battery of claim 18, wherein the fluidic ionically-conductive material comprises a flowable solid electrolyte material, wherein the flowable, solid electrolyte material comprises a lithium phosphorous sulfide.
